(19) United States
(12) Patent Application Publication
(10) Pub. No.: US 2004/0209666 A1
(43) Pub. Date: Oct. 21, 2004

(54) Gaming machine

(76) Inventors: Hirohisa Tashiro, Tokyo (JP); Hideaki Fujii, Tokyo (JP); Wataru Okada, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/697,004

(22) Filed: Oct. 31, 2003

(30) Foreign Application Priority Data
Nov. 19, 2002 (JP) 2002-335226

(51) Int. Cl. G07F 17/34

(52) U.S. Cl. 463/20

(57) ABSTRACT

The game result display means of the gaming machine (1) includes the reels (3L, 3C, 3R) and the liquid crystal display device (31) arranged at a more front side than the display area of the reels (3L, 3C, 3R), and the liquid crystal display device (31) has the symbol display areas through which the symbols of the reels (3L, 3C, 3R) are transmittably displayed and the window frame display areas (22L, 22C, 22R) are formed around the symbol display areas.

### FIELD OF TECHNOLOGY

The present invention relates to a gaming machine having variable display means for variably displaying various symbols necessary for a game and control means such as microcomputer and the like for controlling the variable display, the gaming machine including so-called Japanese pachi-slot machine; slot machine; ball flipping machine such as the first grade˜third grade Japanese pachinko machine, arrange ball machine, mah-jong ball gaming machine or slit-slot machine; video slot machine; video poker machine and the like.

### DESCRIPTION OF RELATED ART

For example, the Japanese pachi-slot machine has a mechanically variable display device in which it is provided a plurality of rotating reels each of which variably displays plural symbols within a display window arranged in front of the machine, the reels being parallel provided in plural lines. According to start operation by a player, the control means drives and controls the variable display device and the reels are rotated, thereby symbols on the reels are variably displayed. And rotation of each reel is stopped automatically or based on stop operation by the player. At that time, in a case that the symbols of each reel displayed within the display window comprises a predetermined combination (the winning mode), game media such as medals or coins are paid out, thereby a predetermined benefit is given to the player.

Further, it is previously proposed a gaming machine having a plurality of reel drums, reel strips each of which is arranged on an outer periphery of each reel drum and on each outer surface of which the symbols are described in a divided manner, light sources each of which illuminates the symbol division on each reel strip from the backside thereof and is arranged within each reel drum and control means for controlling illumination by the light sources. Here, in the reel strip, the symbol portion is made semitransparent and the background of the symbol is made transparent or semitransparent, and the light source is constructed from a plurality of luminous diodes arranged in a dot-matrix manner. The control means controls light emission of each luminous diode, thereby light emission of the light source is controlled so as to display characters or figures by the emitted diodes.

See, for example, Japanese unexamined Publication No. 2001-353255.

### SUMMARY OF THE INVENTION

However, the display window in the above mentioned gaming machine is only opened so as to be able to see and recognize each of reels, thus the display window has no interest.

The object of the present invention is to provide a gaming machine which includes first display means and second display means arranged at a more front side than a display area of the first display means when seen from a front side of the gaming machine, window frame display areas being formed in the second display means, thereby interest for games can be enhanced.

The gaming machine of the present invention comprises: game result display means for displaying a game result thereon; and beneficial state generating means (for example, the CPU 43 mentioned later) for generating a beneficial state for a player when a predetermined game result is displayed on the game result display means; wherein the game result display means includes first display means (for example, the reels 3L, 3C, 3R) and second display means (for example, the liquid crystal display device 31 mentioned later) arranged at a more front side than a display area of the first display means when seen from a front side of the gaming machine, wherein the first display means includes a plurality of symbol display parts (for example, the reel sheets mentioned later) capable of variably displaying one or more of the symbols and conducting stop display thereof; and wherein the second display means has symbol display areas through which the symbols displayed on the first display means are transmittably displayed and window frame display areas (for example, the window frame display areas 22L, 22C, 22R mentioned later) are formed around the symbol display areas in the second display means.

In the gaming machine of the present invention, display mode of the window frame display area can be changed (moving and displaying of the rat fireworks, enlargement display of the window frame display area).

In the gaming machine of the present invention, a light transmittance rate of the symbol display area in the second display means can be changed when the display mode of the window frame display area is changed.

In the gaming machine of the present invention, the display mode of the window frame display area can be changed substantially at the same time that the stop display of the symbol is conducted.

The gaming machine of the present invention, further comprises internal winning combination determination means (for example, the CPU 43 mentioned later) for determining an internal winning combination, and the display mode of the window frame display area can be changed when the internal winning combination determination means determines a predetermined combination (for example, bonus such as BB or RB mentioned later) as the internal winning combination.

According to the present invention, it is provided the gaming machine in which the game result display means includes first display means and second display means arranged at a more front side than a display area of the first display means when seen from a front side of the gaming machine, and the first display means includes a plurality of symbol display parts capable of variably displaying one or more of the symbols and conducting stop display thereof and the second display means has symbol display areas through which the symbols displayed on the first display means are transmittably displayed and window frame display areas are formed around the symbol display areas in the second display means. Thereby, interest for games can be enhanced.

### BRIEF DESCRIPTION OF THE DRAWINGS

[FIG. 1]

FIG. 1 is a perspective view of a slot machine according to the embodiment,

[FIG. 2]

FIG. 2 is an explanatory view showing a panel display part and a liquid crystal display part.

[FIG. 3]

FIG. 3 is an explanatory view showing an external appearance of a reel mechanism in which lamps are arranged within each reel.

[FIG. 4]

FIG. 4 is a perspective view showing a reel and a circuit board for receiving LEDs therein arranged in the reel.

[FIG. 5]

FIG. 5 is a perspective view roughly showing a construction of the liquid crystal display device.

[FIG. 6]

FIG. 6 is an exploded perspective view showing a part of the liquid crystal display device.

[FIG. 7]

FIG. 7 is an explanatory view for explaining function of the LED lamps and fluorescent lamps.

[FIG. 8]

FIG. 8 is a block diagram showing an electrical circuit in the embodiment.

[FIG. 9]

FIG. 9 is a block diagram showing a construction of a sub-control circuit.

[FIG. 10]

FIG. 10 is an explanatory view showing an example of a display mode of a window frame display area.

[FIG. 11]

FIG. 11 is an explanatory view showing an example of a display mode of a window frame display area.

### DETAILED DESCRIPTION OF THE INVENTION

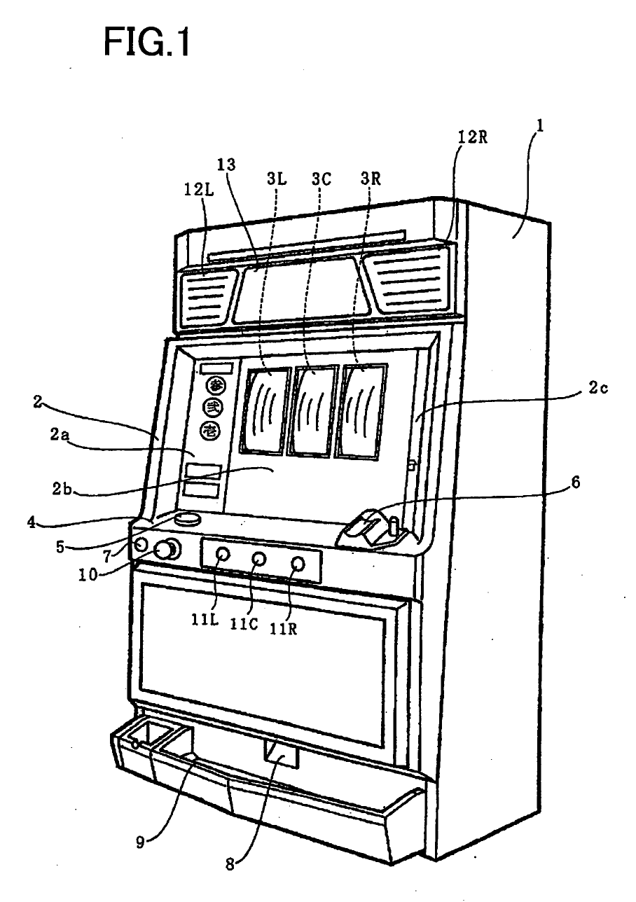

FIG. 1 is a perspective view showing an outlined shape of a gaming machine 1 according to one embodiment of the present invention. Here, the gaming machine 1 is a so-called Japanese pachi-slot machine. Though, in the gaming machine 1, a player plays games by using game media such as coins, medals or tokens, or a card in which information of game value given to the player is stored, it will be described hereinafter the gaming machine 1 in which medals are used.

Presently, the Japanese pachi-slot machine in the main current has a plural kinds of winning modes. In particular, when a predetermined winning combination is accepted, the player can obtain a more beneficial gaming state than a normal gaming state for a predetermined period without finishing the game by only one payout of medals. As such winning combination, there exist one winning combination in which the game relatively giving large benefit to the player can be done in predetermined times (this winning combination is called “BIG BONUS” and abbreviated as “BB” hereinafter) and another winning combination in which the game relatively giving small benefit to the player in predetermined times (this winning combination is called “REGULAR BONUS” and abbreviated “RB” hereinafter).

And in the Japanese pachi-slot machine in the main current, in order to materialize the winning combination that medals or coins are paid out when a predetermined symbol combination stands side by side along pay lines made activated (abbreviated as “activated line” hereinafter), it is required to internally win the winning combination (abbreviated as “internal winning” hereinafter) by the internal lottery treatment (abbreviated as “internal lottery” hereinafter) and to conduct stop operation of the symbols by the player at the timing that the symbol combination indicating the winning combination internally won (abbreviated as “internal winning combination” hereinafter) can stop along the activated lines. That is to say, even if the winning combination is internally won, the winning according to the internal winning combination cannot be realized when the stop operation by the player is out of the timing. Namely, in the present Japanese pachi-slot machine in the main current, it is required technique to conduct stop operation of the symbols at good timing. This technique is called “observation push”, thus it is highly appreciated the technical intervention in the present Japanese pachi-slot machine.

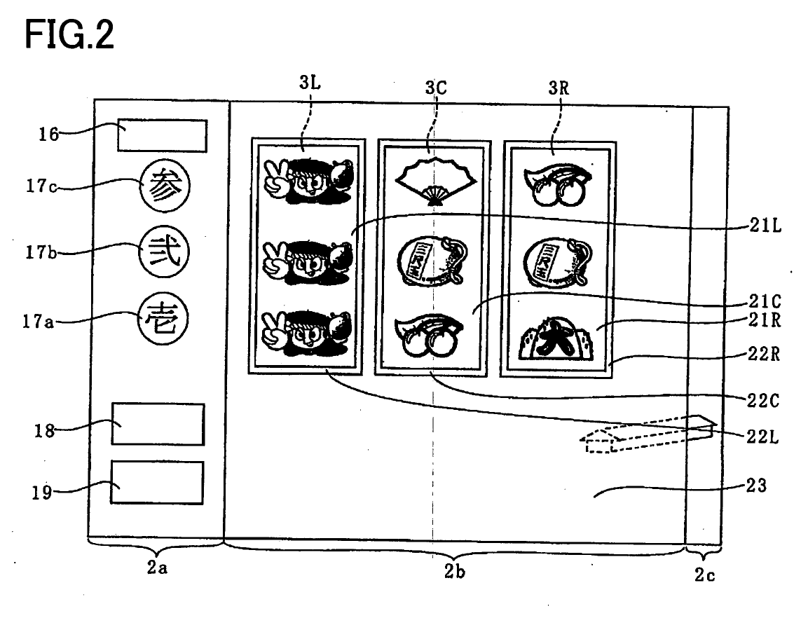

At the front surface of a cabinet 2 entirely forming the gaming machine 1, a panel display unit 2a, a liquid crystal display unit 2b and a fixed display unit 2c, which have substantially vertical planes, are formed. As for the panel display unit 2a, the liquid crystal display unit 2b and the fixed display unit 2c, they will be described with reference to FIG. 2, hereinafter. In the cabinet 2 (at the rear side of the liquid crystal display unit 2b), three reels 3L, 3C, 3R (the first display means comprising the game result display means), on each outer periphery of which symbol line comprising a plural kinds of symbols is described, are rotatably arranged along a horizontal line. The reels 3L, 3C, 3R form the variable display means. Symbols on each reel (rotational drum type display device) can be seen through symbol display areas 21L, 21C, 21R (shown in FIG. 2 hereinafter). Each reel is constructed so as to be able to rotate at a constant rotational speed (for example, 80 rotations/minute).

At a lower position of the panel display unit 2a, the liquid crystal display unit 2b and the fixed display unit 2c, a frontward projection portion 4 having a substantially horizontal plane is formed. At the left side of the frontward projection portion 4, it is arranged a BET switch 5 for betting medals credited by button pressing operation. At the right side of the frontward projection portion 4, a medal insertion slot 6 is formed. At the front left side of the frontward projection portion 4, it is provided a c/p switch 7 for switching credit/payout of medals obtained in the game by the player based on button pressing operation. On the basis of switching by the c/p switch 7, medals are paid out from a medal payout opening 8 and the paid medals are accumulated in a medal receiving tray 9.

At the right side of the C/P switch 7, a start lever 10 (game start instruction means operable by the player), which starts rotation of the reels when operated by the player and starts variable display of the symbols (starts the game) within each of the symbol display areas 21L, 21C, 21R (see FIG. 2), is provided so as to be able to rotate within a predetermined angle. At the front center of the frontward projection portion 4 and the right side of the start lever 10, three stop buttons 11L 11C, 11R (game result leading means operable by the player), which is operated to stop rotation of the reels 3L, 3C, 3R, respectively, are arranged. At the upper left and right sides of the cabinet 2, speakers 12L, 12R are arranged. Between the speakers 12L, 12R, a payout table panel 13 which shows winning combinations of the symbols and the number of medals paid out as awards, is provided.

With reference to FIG. 2, the panel display unit 2a, the liquid crystal display unit 2b and the fixed display unit 2c will be explained.

The panel display unit 2a comprises a bonus game information display part 16, BET lamps 17a˜17c, a payout display part 18 and a credit display part 19. Here, the bonus display part 16 is constructed from 7-segment LEDs and displays the game information during the bonus game. The 1-BET lamp 17a, 2-BET lamp 17b and MAX-BET lamp 17c are turned on according to the medal number betted to conduct the game. The 1-BET lamp 17a is turned on when the betted medal number is “1”. The 2-BET lamp 17b is turned on when the betted medal number is “2”. And the MAX-BET lamp 17c is turned on when the betted medal number is “3”. The payout display part 18 and the credit display part 19 are constructed from 7-segment LEDs respectively. The payout display part 18 displays the payout medal number when the winning is materialized. The credit display part 19 displays the medal number accumulated (credited).

The liquid crystal display unit 2b comprises the symbol display areas 21L, 21C, 21R, window frame display areas 22L, 22C, 22R and effect display area 23. The display contents displayed on the liquid crystal display 2b are variably changed according to the variable symbol display mode of the reels 3L, 3C, 3R, stop display mode of the symbols and operation of a liquid crystal display device 31 mentioned hereinafter.

The symbol display areas 21L, 21C, 21R are provided corresponding to the reels 3L, 3C, 3R, respectively, and display the symbols arranged on the outer periphery of the reels 3L, 3C, 3R and various effects thereon. Here, in a case that the reels 3L, 3C, 3R corresponding to the symbol display areas 21L, 21C, 21R are rotating or the stop buttons 11L, 11C, 11R corresponding to the symbol display areas 21L, 21C, 21R are in a operable state for stop operation of the reels 3L, 3C, 3R, each symbol display area 21L, 21C, 21R is transparently displayed so as to be able to easily recognize the symbols arranged on the outer peripheries of the reels 3L, 3C, 3R, and effect effected through still images or moving images by, for example, symbols, letters, figures, marks, characters is not conducted.

The window frame display areas 22L, 22C, 22R are formed so as to enclose each symbol display area 21L, 21C, 21R and represents the frames of the symbols arranged on the outer peripheries of the reels 3L, 3C, 3R.

The effect display area 23 is formed in an area other than the symbol display areas 21L, 21C, 21R and the window frame display areas 22L, 22C, 22R in the liquid crystal display unit 2b. This effect display area 23 displays the image (representing so-called “WIN LAMP”) conclusively indicating that bonus winning is realizable, the effect to increase interest for games and the information necessary for the player to beneficially advance the game.

The fixed display unit 2c is an area to display the images determined beforehand. Concretely, the fixed display unit 2c displays” a part of row houses” which is described on a display plate 33 mentioned hereinafter. By combining the image displayed on the fixed display unit 2c and the image displayed on the effect display area 23, one still image or moving image can be displayed. In the embodiment, one complete image of the row houses can be displayed.

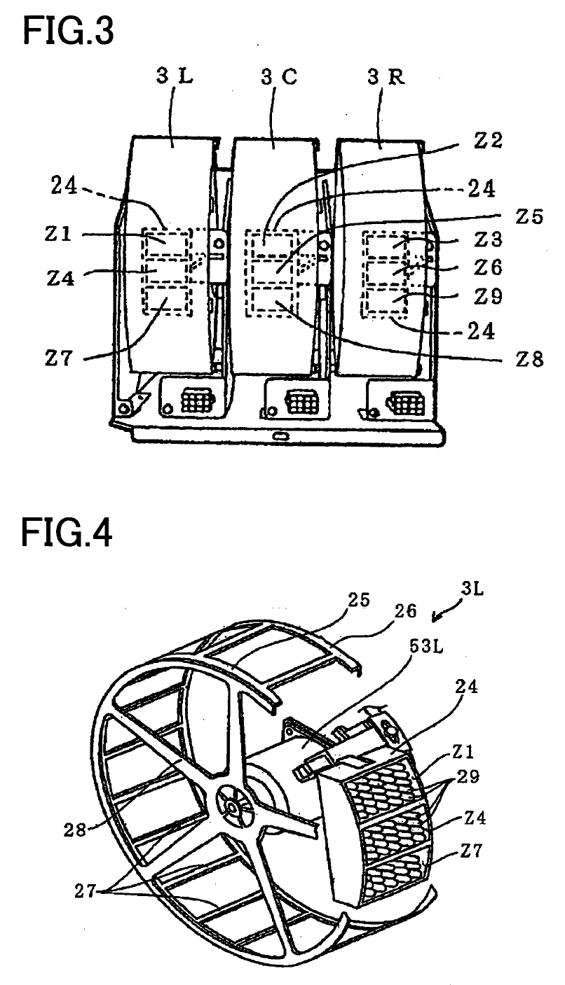

Further, with reference to FIGS. 3 and 4, LED lamps 29 arranged in the reels 3L, 3C, 3R will be described. The LED lamps 29 function as illumination means for illuminate the symbols arranged on the outer peripheries of the reels 3L, 3C, 3R and one of illumination means for illuminating the areas mainly corresponding to the symbol display areas 21L, 21C, 21R within an area of a liquid crystal panel 34 (mentioned later). Thus, the LED lamps 29 function as common illumination means for commonly illuminating the above symbols and the areas. And the LED lamps 29 also function as rear illumination means for illuminating the first display means from the backside thereof.

As shown in FIG. 3, in the reels 3L, 3C, 3R, there are arranged LED receiving circuit boards 24 which are positioned behind the symbols of three symbol lines (totally nine symbols), each symbol line appearing in each of symbol display areas 21L, 21C, 21R when rotation of the reels 3L, 3C, 3R stops. Each LED receiving circuit board 24 has three LED receiving portions in each of which a plurality of LED lamps 29 are provided. Hereinafter, among nine LED receiving portions, the LED receiving portion is serially represented by Z1, Z2 and Z3 from the left portion in the horizontal upper line, the LED receiving portion is serially represented by Z4, Z5 and Z6 from the left portion in the horizontal center line and the LED receiving portion is serially represented by Z7, Z8 and Z9 from the left portion in the bottom horizontal line. The LED lamp 29 illuminates the rear side of the reel sheet by white light, the reel sheet being attached to the reel 3L, 3C, 3R along the outer periphery thereof. The reel sheet is made translucent, thus light emitted from the LED lamp 29 permeates to the front plane of the reel sheet.

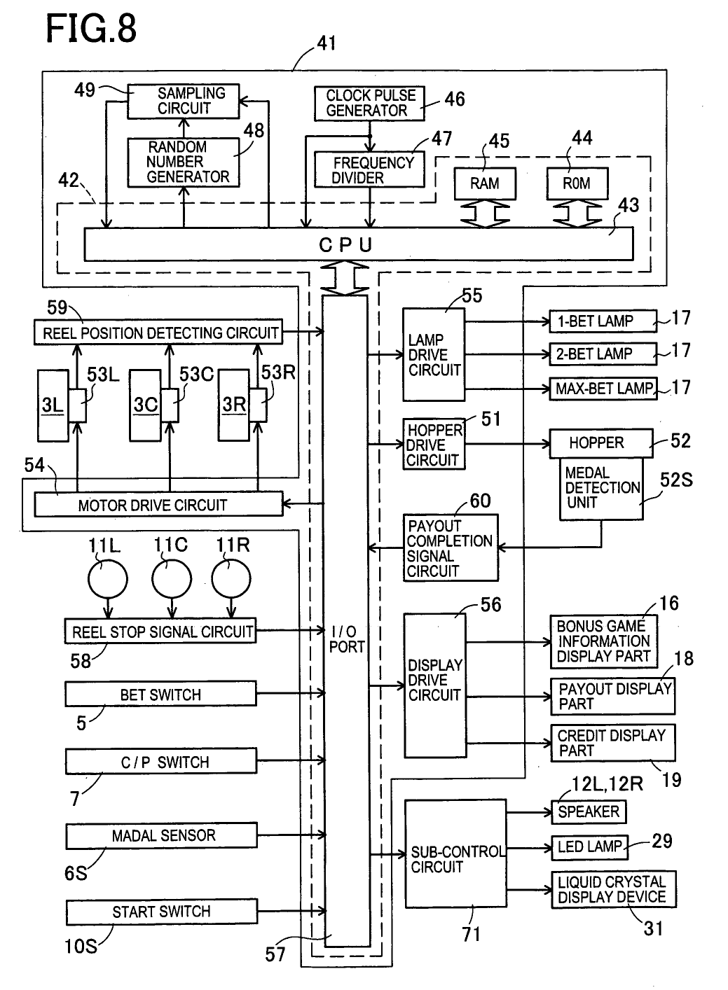

As shown in FIG. 4, the reel 3L is constructed from a cylindrical frame construction in which two circular frames 25 and 26 with the same shapes are connected by a plurality of connecting members 27 while separating with a distance (corresponding to the reel width) therebetween, and transmitting members 28 for transmitting driving force of a stepping motor 53L (see FIG. 8) arranged in the center position of the frame construction to the circular frames 25 and 26. Here, the reel sheet attached to the outer periphery of the reel 3L is omitted.

The LED receiving circuit board 24 arranged within the reel 3L has three LED receiving portions Z1, Z4 and Z7, each receiving a plurality of LED lamps 29. The LED receiving circuit board 24 is arranged so that the LED receiving portions Z1, Z4, Z7 position at rear sides of the symbols (totally three symbols), respectively, the symbols being seen through the symbol display area 21L by the player. Here, though the reels 3C and 3R are not shown, both reels have the same construction and the LED receiving circuit board 24 is arranged within each reel.

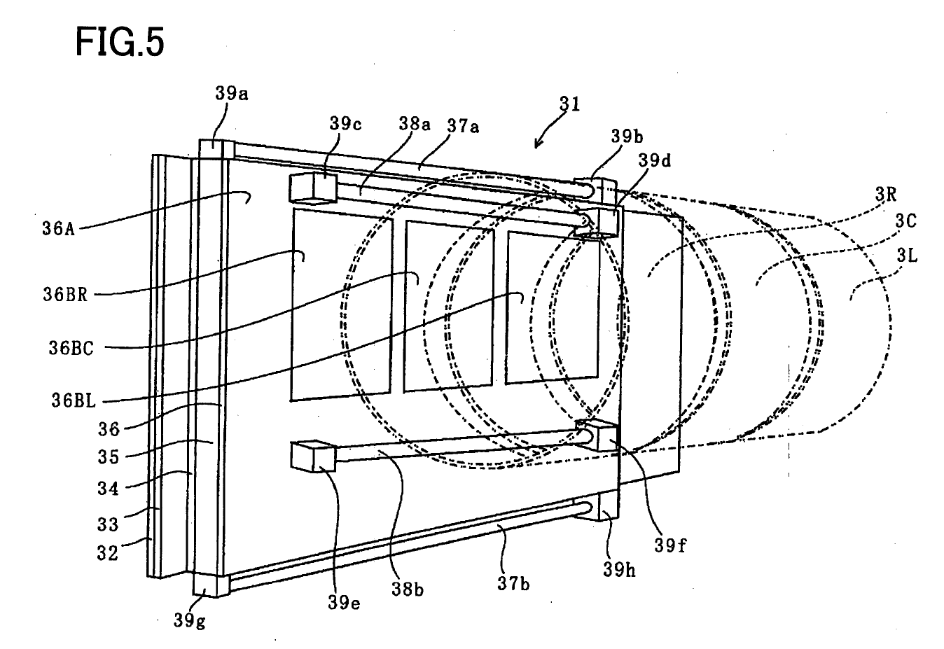

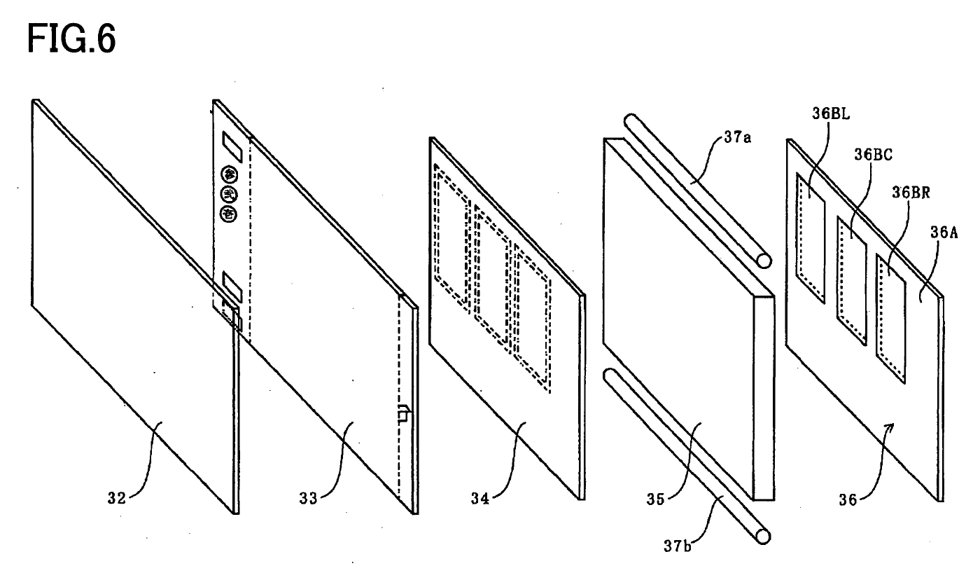

Next, with reference to FIGS. 5 and 6, a transmission type liquid crystal display device 31 (corresponding to the second display means constructing the game result display means) will be described. FIG. 5 is a perspective view (seeing from the rear side of the cabinet 2) showing outline construction of the liquid crystal display device 31. FIG. 6 is an exploded perspective view showing a partial construction of the liquid crystal display device 31.

The liquid crystal display device 31 is constructed from a protect glass 32, a display plate 33, a liquid crystal panel 34, a light guide plate 35, a reflection film 36, fluorescent lamps 37a, 37b, 38a, 38b functioning as so-called white light sources (capable of emitting light including light having all wavelengths with a predetermined ratio so that specific colors are inconspicuous to eyes of persons), lamp holders 39a˜39h and a flexible circuit board (not shown) comprising a table carrier package (TCP) mounting an IC for driving the liquid crystal panel, the TCP being connected to a terminal portion of the liquid crystal panel 34. The liquid crystal display device 31 is arranged at a more front side than the display areas of the reels 3L, 3C, 3R (more front side than the display planes thereof) so as to spread over the reels 3L, 3C, 3R. And the reels 3L, 3C, 3R and the liquid crystal display device 31 are independently arranged (with a predetermined distance therebetween).

The protect glass 32 and the display plate 33 are made of light transmittable material. The protect glass 32 is provided with an object to protect the liquid crystal panel 34. At the areas corresponding to the panel display unit 2a of the display plate 33 and the fixed display unit 2c, images are described. Here, various display parts positioned at the rear side of the area in the display plate 33 corresponding to the panel display unit 2a and electric circuits for operating the BET lamps 17a˜17c are omitted to show.

The liquid crystal panel 34 is formed by filling liquid crystal material in clearance formed between the transparent plate such as a glass plate on which thin film transistor layer is formed and the transparent plate facing thereto. The display mode of the liquid crystal panel 34 is set to normally white. Here, “normally white” means a construction that the liquid crystal panel 34 becomes in a white display state (light can advance toward the display plane, that is, light transmitted can be seen from outside) when the liquid crystal panel 34 is not driven. By utilizing the liquid crystal panel 34 constructed to have the normally white mode, the symbols (variable display and stop display of the symbol display parts) arranged on the reels 3L, 3C, 3R can be seen and recognized through the symbol display areas 21L, 21C, 21R even if it occurs a trouble that the liquid crystal panel cannot be driven. Thereby, the player can continue the game. That is to say, if the above trouble occurs, it can be conducted the game based on the basic function such as the variable display and the stop display of the reels 3L, 3C, 3R.

The light guide plate 35 is arranged at the rear side of the liquid crystal panel 34 in order to lead the light emitted from the luminescent lamps 37a, 37b to the liquid crystal panel 34 (to illuminate the liquid crystal panel). For example, the light guide plate 35 is constructed from the light transmittable member with thickness of about 2 cm (having light transmitting ability) made of acrylic resin.

As the reflection film 36, for example, it is used the member that silver deposition layer is formed on white polyester film or aluminium thin film. The reflection film 36 reflects light led to the light guide plate 35 toward the front side thereof. This reflection film 36 is constructed from a reflection area 36A and non-reflection areas (non-transmittable areas) 36BL, 36BC, 36BR. The non-reflection areas 36BL, 36BC, 36BR are formed as the light transmittable areas which are made of transparent material and transmit the light led thereto without reflecting, and are arranged at each front position of symbols (totally three symbols) displayed when rotation of the reels 3L, 3C, 3R is stopped. In this case, areas corresponding to the reel sheet function as the light transmittable areas. Concretely, sizes and positions of the non-reflection areas 36BL, 36BC, 36BR coincide with those of the symbol display areas 21L, 21C, 21R. The reflection area 36A reflects the light led thereto and functions as one of the illumination means for the area mainly corresponding to the window frame display areas 22L, 22C, 22R and the effect display area 23 within the area on liquid crystal panel 34. According to the above construction, since the player can see and recognize variable display and stop display of the symbols in the symbol display areas through the light transmittable areas in reflection means, the player can enjoy the game based on the display manner in the symbol display areas and the liquid crystal display device.

The fluorescent lamps 37a and 37b are arranged along the upper edge and the lower edge of the light guide plate 35 and both ends of the fluorescent lamp 37a, 37b are supported by lamp holders 39. The fluorescent lamps 37a and 37b function as illumination means for the area mainly corresponding to the window frame display areas 22L, 22C, 22R and the effect display area 23 within the area on the liquid crystal panel 34. Namely, the fluorescent lamps 37a and 37b emit light led to the light guide plate 35 (the lamps separately lead light to the light guide plate 35).

And the fluorescent lamps 38a and 38b are arranged so as to face toward the reels 3L, 3C, 3R at the upper and lower positions on the rear side of the reflection film 36. The light, which is emitted from the fluorescent lamps 38a and 38b and reflected on the surface of the reels 3L, 3C, 3R, further entered in the non-reflection areas 36BL, 36BC, 36BR, illuminates the liquid crystal panel 34. Therefore, the fluorescent lamps 38a and 38b function as the illumination means for illuminating the symbols arranged on the reels 3L, 3C, 3R and one of the illumination means for the areas mainly corresponding to the symbol display areas 21L, 21C, 21R within the area on the liquid crystal panel 34. The fluorescent lamps 38a and 38b function as common illumination means for illuminating both the above symbols and areas. Further, the fluorescent lamps 38a and 38b also function as the forward illumination means for illuminating the first display means from the front side thereof.

As mentioned above, the first display means and the second display means are commonly illuminated by the common illumination means. That is to say, since not only the first display means but also the second display means are illuminated by the light emitted from the common illumination means, cost becomes cheaper than a case that the illumination means is independently arranged for each display means. Further, by controlling the common illumination means illumination control can made simple and the same illumination for two display means can be also realized at the same time.

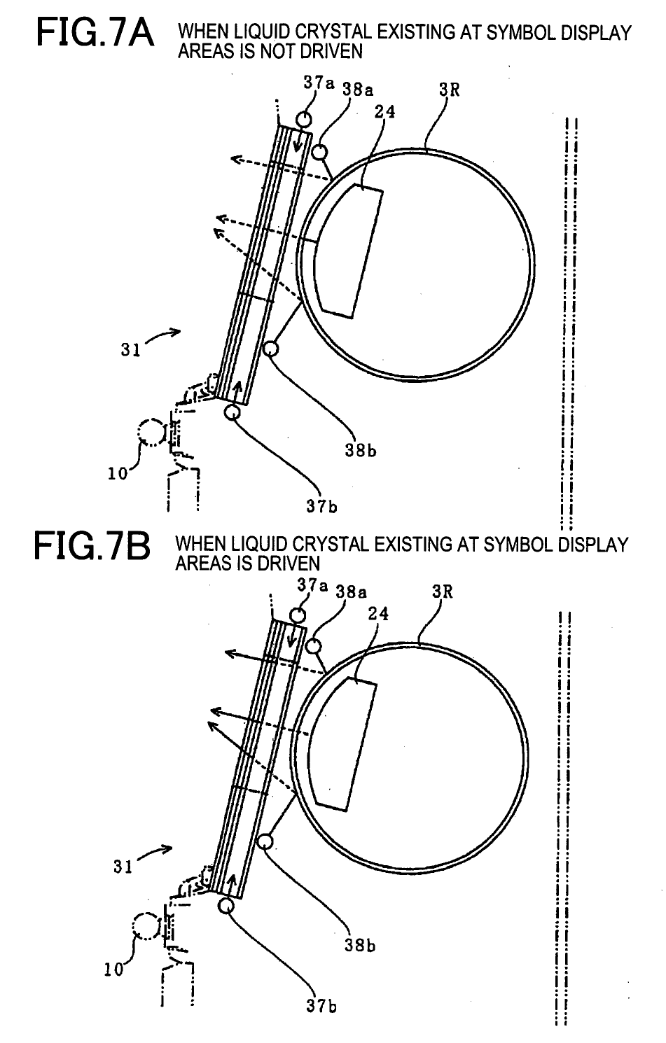

Next, with reference to FIG. 7, function of the LED lamp 29 and the fluorescent lamps 37a, 37b, 38a, 38b will be described. In FIG. 7, moving direction of the emitted light from the lamp is shown by arrows.

FIG. 7 (1) schematically shows function of each lamp when the liquid crystal existing at the symbol display areas 12L, 21C, 21R is not driven (voltage is not added between the transparent plates of portions corresponding to the symbol display areas in the liquid crystal panel 34).

A part of the light emitted from the fluorescent lamps 38a. 38b is reflected on the reel sheet. And a part of the light emitted from the LED lamps 29 arranged on the LED receiving circuit board 24 penetrates through the reel sheet. Since the above light penetrates through the non-reflection areas 36BL, 36BC, 36BR, the light guide plate 35 and the liquid crystal panel 36 both of which constructs the liquid crystal display device 31, the player can see and recognize the symbols arranged on the reels. Therefore, in a case that the liquid crystal existing at the symbol display areas 12L, 21C, 21R is not driven, the LED lamps 29 and the fluorescent lamps 38a, 38b function as the illumination means for the symbols arranged on the reels 3L, 3C, 3R.

On the contrary, the light emitted from the fluorescent lamps 37a, 37b and led into the light guide plate 35 penetrates through the liquid crystal panel 34 and enters in eyes of the player. That is, the fluorescent lamps 37a, 37b function as the illumination means for the area in the liquid crystal panel 34 corresponding to the above window frame display areas 22L, 22C, 22R and the effect display area 23.

FIG. 7 (2) schematically shows function of each lamp when the liquid crystal existing at the symbol display areas 12L, 21C, 21R is driven (voltage is added between the transparent plates of portions corresponding to the symbol display areas in the liquid crystal panel 34).

A part of the light emitted from the fluorescent lamps 38a, 38b is reflected on the reel sheet. And a part of the light emitted from the LED lamps 29 penetrates through the reel sheet. Since a part of the above light is reflected on or absorbed in or penetrated through the areas that the liquid crystal is driven within the area of the liquid crystal panel 34, the player can see and recognize the effect display and the like displayed on the symbol display areas 21L, 21C, 21R. Therefore, in a case that the liquid crystal existing at the symbol display areas 12L, 21C, 21R is driven, the LED lamps 29 and the fluorescent lamps 38a, 38b function as the illumination means corresponding to the symbol display areas 21L, 21C, 21R within the area of the liquid crystal panel 34.

Here, in a case that a part of the areas corresponding to the symbol display areas 21L, 21C, 21R within the area of the liquid crystal panel 34 is driven, the LED lamps 29 and the fluorescent lamps 38a, 38b function as the illumination means for the symbols arranged on the reels 3L, 3C, 3R and for the areas corresponding to the liquid crystal not driven in the symbol display areas 21L, 21C, 21R within the liquid crystal panel 34.

FIG. 8 shows the circuitry construction including a main control circuit 41 for controlling game treatment operation in the gaming machine 1, peripheral devices electrically connected to the main control circuit 41, and a sub-control circuit 71 for controlling the liquid crystal display device 31 and speakers 12L, 12R based on the control command transmitted from the main control circuit 41. The main control circuit 41 and the sub-control circuit 71 construct the game result display control means. The main control circuit 41 has functions as the internal winning combination determination means, the first display control means and the beneficial state producing means. The internal winning combination determination means determines the internal winning combination among plural winning combinations based on the output from the game start instruction means. The first display control means controls the first display means based on the determined result by the internal winning combination determination means and the output by the game result leading means. The beneficial state producing means produces beneficial state for the player when a predetermined game result is displayed on the game result display means. And the sub-control circuit 71 controls the second display means based on the determined result by the internal winning combination determination means and the output from the game result leading means.

The main control circuit 41 is mainly constructed from a microcomputer 42 arranged on the circuit board, in addition to a circuit for sampling random number. The microcomputer 42 includes a CPU 43 conducting control operation according to preset program, a ROM 44 and a RAM 45.

To the CPU 43, a clock pulse generator 46 generating reference clock pulses, a frequency divider 47, a random number generator 48 for generating random numbers sampled and a sampling circuit 49 are connected respectively. Here, as the means for sampling random number, it may construct that random number sampling is done according to the operation program of the CPU 43 in the microcomputer 42. In this case, the random number generator 48 and the sampling circuit 49 may be omitted, or these may be remained to back up random number sampling operation.

In the ROM 44 of the microcomputer 42, there are stored a probability lottery table utilized for judging random number sampling conducted every operation of the start lever 10 (start operation), a stop control table for determining stop combination of the reels according to operation of the stop buttons and various control instructions (commands) to transmit to the sub-control circuit 71. Here, the sub-control circuit 71 never transmits commands, information and the like to the main control circuit 41, but one-way transmission from the main control circuit 41 to the sub-control circuit 71 is only done.

In the circuit of FIG. 8, as main actuators controlled based on control signal from the microcomputer 42, there are various lamps (1-BET lamp 17a, 2-BET lamp 17b, MAX-BET lamp 17c), various display parts (bonus game information display part 16, payout display part 18, credit display part 19), a hopper 52 as the game value giving means (including drive part for payout) accumulating medals and paying out a predetermined number of medals according to instruction by a hopper drive circuit 51 and stepping motors 53L, 53C, 53R for driving the reels 3L, 3C, 3R to be rotated.

A motor drive circuit 54 for driving and controlling the stepping motors 53L, 53C, 53R, a hopper drive circuit 51 for driving and controlling the hopper 52 and a lamp drive circuit 56 for driving and controlling various lamps and a display drive circuit 56 for driving and controlling display parts are connected to the output part of the CPU 43 through an I/O port 57. These drive circuits controls operation in each of the actuators when receiving control commands such as drive commands each of which is output from the CPU 43.

Further, as for the input signal producing means mainly producing input signals which are necessary for the microcomputer 42 to produce the control commands, there are provided the BET switch 5, the medal sensor 6S for detecting the inserted medals, the C/P switch 7, the start switch 10S, the reel stop signal circuit 58, the reel position detecting circuit 59 and the payout completion signal circuit 60. These are also connected to the CPU 43 through the I/O port 57.

The medal sensor 6S detects the medals inserted in the medal insertion slot 6. The start switch 10S detects operation of the start lever 10. The reel stop signal circuit 58 produces stop signal corresponding to operation of each stop button 11L, 11C, 11R. The reel position detecting circuit 59 provides signal to detect the position of each reel 3L, 3C, 3R with the CPU 43 when receiving pulse signal from the reel rotation sensor. The payout completion signal circuit 60 produces signal for detecting the medal payout completion when the count number (corresponding to the medal number paid out from the hopper 52) by the medal detection unit 52S reaches to data of a designated number.

In the circuit shown in FIG. 8, the random number generator 48 generates random numbers within a predetermined numeral range and the sampling circuit 49 conducts sampling of one random number at the suitable timing after the start lever 10 is operated. Based on the thus sampled random number and the probability lottery table stored in the ROM 44, the internal winning combination of the symbols is determined. And after the internal winning combination is determined, sampling of the random number is conducted again to select the “stop control table”.

After rotation of the reels 3L, 3C, 3R is started, it is counted the number of the drive pulses each of which is provided with each of the stepping motors 53L, 53C, 53R, and the counted number is written in the predetermined area of the RAM 45. The reset pulse is generated from each of the reels 3L, 3C 3R every one rotation thereof, and these reset pulses are input to the CPU 43 through the reel position detecting circuit 59. Based on the thus obtained reset pulses, the count number of drive pulses counted in the RAM 45 is cleared to “0”. Thereby, in the RAM 45, the count number corresponding to the rotational position within one rotation in each of the reels 3L, 3C, 3R is stored.

In order to connect the rotational positions of the reels 3L, 3C, 3R with the symbols described on the outer peripheries of the reels, a symbol table is stored in the ROM 44. In this symbol table, both code numbers, each of which is serially given every a predetermined rotational pitch of each reel 3L, 3C, 3R by setting the rotational position producing the reset pulse as the reference rotational position, and symbol codes, each of which indicates the symbol provided corresponding to each of the code numbers, are connected with each other.

Further, in the ROM 44, a winning symbol combination table is stored. In the winning symbol combination table, winning symbol combinations corresponding to various winnings, medal payout numbers each of which corresponds to each winning and winning determination codes each of which represents each winning, are corresponded with each other. The above winning symbol combination table is referred when the stop control of the left reel 3L, the center reel 3C and the right reel 3R is conducted and when the winning is confirmed after all reels 3L, 3C, 3R are stopped.

When one of winning combinations is internally won by the lottery treatment (probability lottery treatment) based on the above sampling of the random number, the CPU 43 sends stop signals for conducting stop control of the reels 3L, 3C, 3R to the motor drive circuit 54, based on the operation signals sent from the reel stop signal circuit 58 at the timing that the player operates the stop buttons 11L, 11C, 11R and the selected stop control table.

If the symbols stop in a stop mode that the winning combination internally won is realized, the CPU 43 provides the payout command signal to the hopper drive circuit 51, thereby a predetermined number of the medals are paid out from the hopper 52. At that time, the medal detection unit 52S counts the number of medals paid out, and when the number of medals paid out reaches to the designated number, the medal payout completion signal is input to the CPU 43. Thereby, the CPU 43 stops driving of the hopper 52 through the hopper drive circuit 51, as a result, the payout treatment of the medals is terminated.

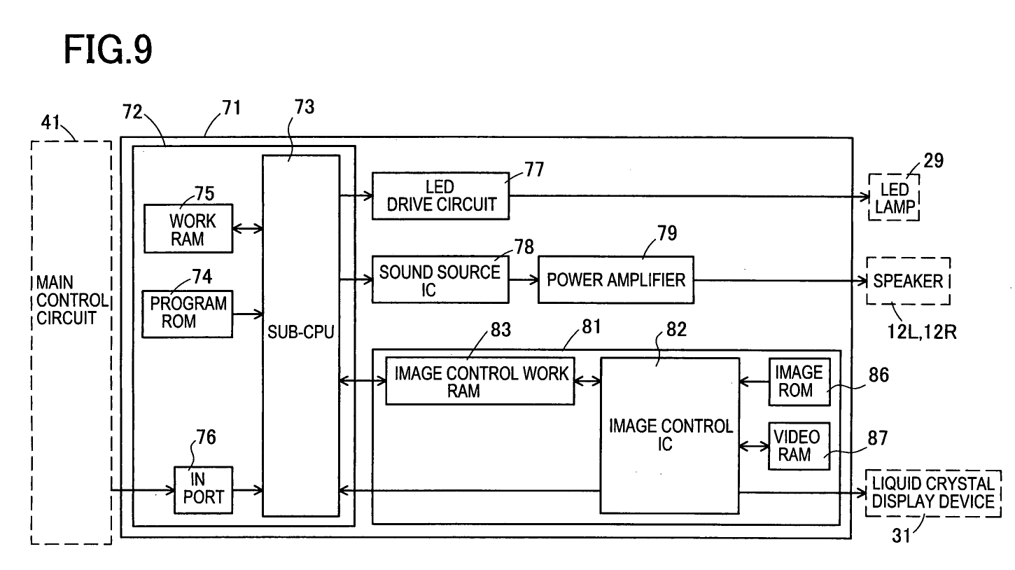

FIG. 9 shows a construction of the sub-control circuit 71. The sub-control circuit 71 conducts turning on and off treatment of the LED lamps 29 based on the control command from the main control circuit 41, display control of the liquid crystal display device 31 and output control of sounds output from the speakers 12L, 12R. This sub-control circuit 71 is constructed on a separate circuit board from the circuit board on which the main control circuit 41 is formed and is mainly constructed from a microcomputer (abbreviated as “sub-microcomputer” hereinafter) 72. The sub-control circuit 71 is constructed from a LED drive circuit 77 as the display control means for controlling a plurality of ornamental lamps, the LED lamps 29 and the fluorescent lamps 37a, 37b which are arranged on the cabinet of the gaming machine 1, an image control circuit 81 as the display control means of the liquid crystal display device 31, a sound source IC 78 for controlling sounds output from the speakers 12L, 12R and a power amplifier 79 acting as the amplifier.

The sub-microcomputer 72 includes a sub-CPU 73 conducting control operation according to the control command sent from the main control circuit 41, a program ROM 74 acting as the memory means and a work RAM 75. Though the sub-control circuit 71 does not have the clock pulse generator, the frequency divider, the random number generator and the sampling circuit, it is constructed so that the random sampling is conducted in the operation program of the sub-CPU 73. And the program ROM 74 stores the control program executed in the sub-CPU 73. Further, the program ROM 74 also stores the image control program concerning with display on the liquid crystal display device 31 and various select tables. The work RAM 75 is constructed as the temporary memory means utilized when the control program is executed by the sub-CPU 73.

The image control circuit 81 is constructed form an image control work RAM 83, an image ROM 86, a video RAM 87 and an image control IC 82. The image control IC 82 determines the display contents displayed on the liquid crystal display device 31 based on parameters designated by the sub-CPU 73. The image control work RAM 83 is used for temporarily storing images when images are formed by the image control IC 82 and when images followingly displayed on the liquid crystal display device 31 are designated to the image control IC 82 by the sub-CPU 73. The image control IC 82 forms images corresponding to display contents determined by the sub-CPU 73 and outputs to the liquid crystal display device 31. The image ROM 86 stores various images to form the images to be displayed. And the video RAM 87 is constructed as the temporary memory means utilized when images are formed in the image control IC 82.

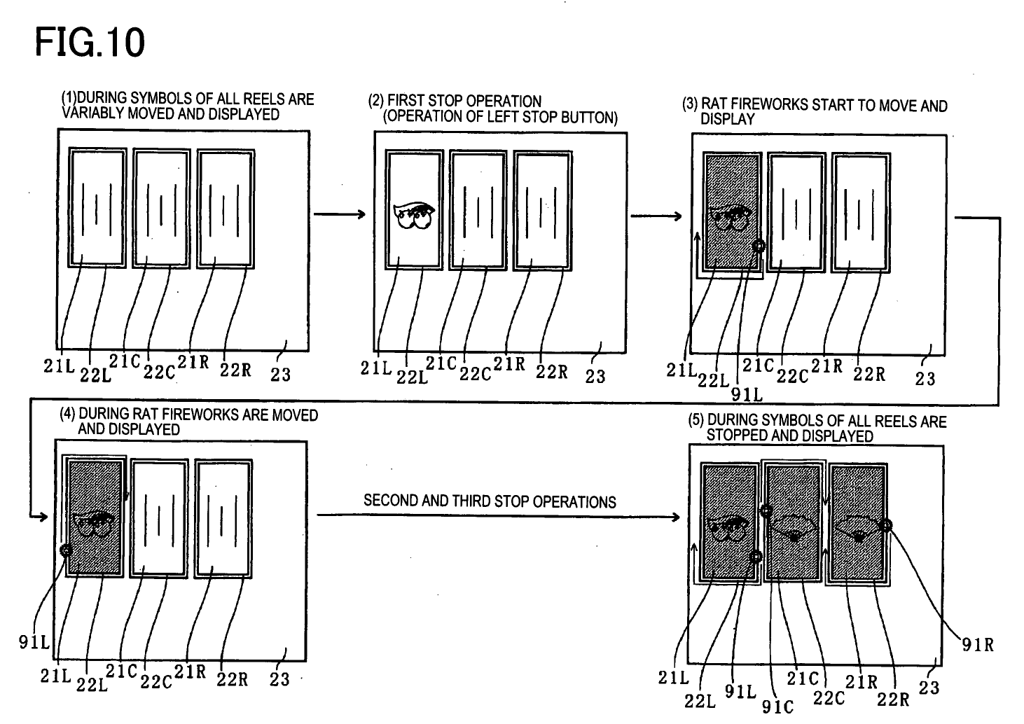

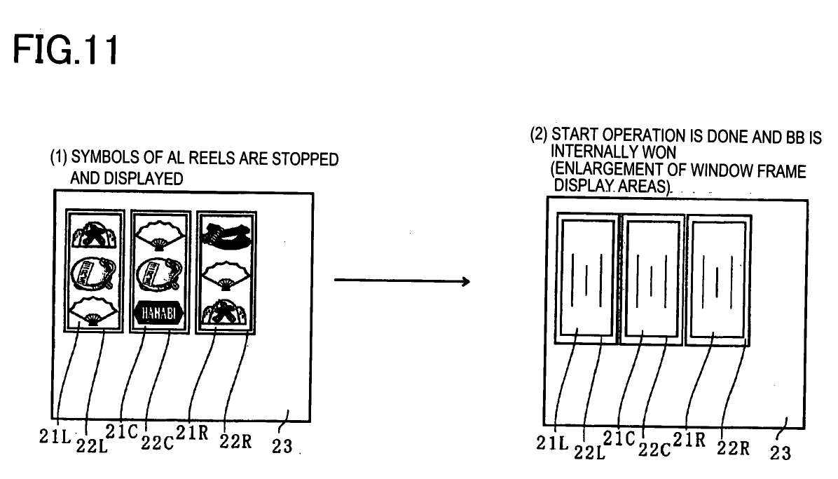

Next, with reference to FIGS. 10 and 11, it will be described an example of a display mode of the window frame display areas 22L, 22C, 22R in the liquid crystal display unit 23.

The second display means (the liquid crystal display device 31) has symbol display areas through which the symbol display of the first display means can be transmittably displayed, and the window frame display areas (the window frame display areas 22L, 22C, 22R) are formed around the symbol display areas. That is to say, since the window display areas are displayed on the liquid crystal display device 31, interest for games will be enhanced in comparison with the gaming machine in which openings like the above mentioned display windows are only formed. And in a case that the window frame display areas are displayed by images, it will be preferable since discoloration does not occur, thus colors and shapes thereof will be easily set on the basis of displaying by images, different from a case that the window frames are fixedly displayed (for example, a case that the above mentioned frames of display windows are displayed with decorations formed beforehand in producing process thereof).

Each window frame display area is constructed so that display mode thereof is changed (for example, the rat fireworks mentioned later are moved and displayed, the window frame display area is enlarged and displayed) based on a predetermined timing (in the embodiment, timing that symbols are stopped and displayed). In detail, each window frame display area is constructed so that display mode of window frame display area is changed substantially at the same time that rotation of the reels is stopped, that is, symbols of the reels are stopped and displayed according to stop operation of the reels.

Since the display mode of window frame display areas is changed, such display mode can be changed corresponding to a gaming state (for example, the predetermined timing and the like), thus degree of freedom for display mode is increased. And in general, the window frame areas are areas to which player's eyes are specifically concentrated, therefore if the display mode thereof is changed, variegated effect can be added. And the window frame display areas are positioned near the symbol display areas through which the first display areas are seen and recognized, thereby it can be realized displaying in which display of the first display means and display of the second display means are harmonized with each other. Further, since the second display means comprises variable display means, it can be conducted display with variegated change of the display mode, not existing in the fixed display means.

Further, in general, the player watches games while considering whether a specific game result is finally led (for example, whether BB combination will be materialized) or whether the specific game result is easily led (for example, whether there is probability that BB combination is materialized according to stop mode of symbols after the second stop operation before the third stop operation is conducted), based on stop display of symbols before final symbol is stopped (for example, stop display of symbols based on the first and second stop operations), even if the stopped and displayed symbol is not the final stopped symbol (for example, stop display of symbols based on the third stop operation). Therefore, it is very preferable that change in the display mode of the window frame display areas occurs or change in light transmittance rate of the symbol display areas occurs at the timing concerning with stop display of symbols watched by the player. And also in this case, if effect by the illumination means arranged in the cabinet or reels or by sounds is combined, expectation of the player can be further improved. And it may be constructed so as to provide vibration means for stimulating the sense of touch of the player by its vibration and to conduct effect by vibration of the vibration means.

At first, with reference to FIG. 10, an example of display mode in the window frame display areas will be described. After the BET operation and start operation are conducted, and “cherry small combination” is determined as the internal winning combination, symbols are variably changed and displayed in the symbol display areas 21L, 21C, 21R, as shown in FIG. 10 (1). Thereafter, the left stop button as the first stop operation is operated, and as shown in FIG. 10 (2), symbol (“cherry symbol”) is stopped and displayed in the symbol display area 21L.

Here, as shown in FIG. 10 (3), the display mode in the window frame display area 22L is changed substantially at the same time that symbol of the left reel 3L is stopped and displayed. That is to say, light transmittance rate of the symbol display area is changed. Concretely, an image 91L indicating “rat fireworks” (abbreviated as “rat fireworks” hereinafter) is started to move and display on the window frame display area 22L. Further, it is constructed so that light does not pass the light transmittable part substantially at the same time that symbol of the left reel 3L is stopped and displayed. That is, light transmittance rate of the symbol display area is made low. Concretely, it is constructed so that the LED lamps 29 do not illuminate the reel sheet of the reel 3L, thereby the symbol of the reel sheet cannot be seen and recognized or is hard to see and recognize. This is called “screening display of symbol” hereinafter. Thereafter, this rat fireworks 91L are moved and displayed along the clockwise direction on the window frame display area 22L, as shown in FIG. 10 (4).

In a case that the display mode of the window frame display area is changed, light transmittance rate (easiness to see the first display means) of the symbol display area is also changed. Thereby, if change in the display mode suddenly occurs or change in light transmittance rate occurs when the player's eyes are concentrated to the symbol display of the first display means, the player images (recognizes) that any change in gaming state occurs in comparison with a case that no change in display mode or light transmittance rate occurs. Based on this, it can be given to the player the expectation that a predetermined beneficial state or a specific beneficial state may occur. And since the above changes occur at places that the player's eyes can easily follow, the player scarcely misses and effect display with impact can be done. Of course, at that time, it is further preferable if the illumination means arranged in the cabinet or reels and sounds are combined. And it may be constructed so as to provide the vibration means for stimulating the sense of touch of the player by its vibration and to conduct effect by vibration of the vibration means. And when changing light transmittance rate, light transmittance rate of the symbol display area may be made high. In this case, illuminance of the LED lamps 29 illuminating the reel sheet of the reel 3L may be raised. And it may be provided illumination means for light transmitting to raise the illuminance.

Next, when the second stop operation is conducted, variable display of the rat fireworks on the window frame display area and the screening display of symbol in the symbol display area are conducted substantially at the same time that the symbol corresponding to the second stop operation is stopped and displayed. Thereafter, when the third stop operation is done, variable display of the rat fireworks on the window frame display area and the screening display of symbol in the symbol display area are conducted substantially at the same time that the symbol corresponding to the third stop operation is stopped and displayed. As shown in FIG. 10 (5), the rat fireworks 91L are moved and displayed on the window frame display area 22L, the rat fireworks 91C are moved and displayed on the window frame display area 22C, and the rat fireworks 91R are moved and displayed on the window frame display area 22R. And in each of symbol display areas 21L, 21C, 21R, the screening display of symbol is conducted.

Next, with reference to FIG. 11, an example of display mode of the window frame display area will be described.

In the above mentioned display example, though the variable display on each of the window frame display areas and the screening display of symbol in each of the symbol display areas are conducted substantially at the same time that each reel is stopped and displayed, FIG. 11 shows a display mode that the window frame display areas are variably displayed when the CPU 43 as the internal winning combination determination means determines a predetermined combination as the internal winning combination. That is to say, the display mode of the window frame display area is changed when the CPU 43 determines the predetermined combination as the internal winning combination.

In a case that the predetermined combination is determined as the internal winning combination, there will exist cases that change in the display mode of the window frame display areas or change in light transmittance rate of the symbol display areas occurs. Thereby, since there will be a case that expectation of the player is not betrayed, interest for games is extremely improved. For instance, when the internal winning combination is determined to BB, the display mode of the window frame display areas or light transmittance rate of the symbol display areas is changed, thereby the player can see and recognize that the internal winning combination is determined to BB by seeing and recognizing change in the display mode of the window frame display areas or change in light transmittance rate of the symbol display areas. Namely, based on such changes, it is notified to the player that there will be chances which give any benefits to the player.

FIG. 11 (1) shows a mode in which symbols are stopped and displayed. Thereafter, when the start operation is done and the internal winning combination is determined to BB, variable display in each of the window frame display areas is conducted substantially at the same time that above determination is done. Here, based on variable display in the window frame display area, the window frame display area is enlarged and displayed.

Though description is done according to the embodiment in the above, the present invention is not limited to the above.

The above mentioned second display means may be constructed from the liquid crystal display device (for example, the liquid crystal display device 31 already mentioned) including the liquid crystal panel (for example, the liquid crystal panel 34 already mentioned), the light transmittable means (for example, the light guide plate 35 already mentioned) arranged at the rear side of the liquid crystal panel, individual illumination means (for example, the fluorescent lamps 37a, 37b) for producing light entering in the light transmittable means and the reflection means (for example, the reflection film 36 already mentioned) for reflecting light entered in the light transmittable means toward the liquid crystal panel arranged at the front side of the light transmittable means, and area in a part of the reflection means (for example the non-reflection areas 36L, 36C, 36R already mentioned) may be made light transmittable and the window frame display areas may be formed and displayed so as to enclose the light transmittable areas on the liquid crystal panel.

Further, it may be provided the light transmittable mode memory (for example, the image ROM 86) means for storing a plurality of display modes of images (for example, characters and the like) including the visible area and the light transmittable mode select means (the sub-CPU 73) for selecting one or plural display modes among the plural display modes stored in the light transmittable mode memory means, the second display means may display the image including the visible area based on the selected result by the light transmittable mode select means. Thereby, various display modes can be displayed and the player does not lose interest for the displayed contents. As a result, interest for games can be more highly raised.

In the embodiment, although the display mode of the above mentioned window frame display area is changed substantially at the same timing as a predetermined timing (symbols are stopped and displayed and the internal winning combination is determined to BB), such timing is not limited to this. As the predetermined timing, it may be utilized the timing that predetermined images are started to display or displayed or display of the predetermined images is ended. In this case, as the predetermined images, it can utilize the images displayed when power of the gaming machine is turned on, when the RAM (the image control work RAM, the RAM, video RAM mentioned respectively) is cleared, when backup is restored, when so-called demonstration images for waiting players (waiting images) are displayed, when abnormality (error) occurs in the gaming machine and when warning is done. And as the predetermined timing, it can be utilized timing when variable display is started, while variable display is conducted and when variable display is ended, in the predetermined display means. In this case, the predetermined display means may be the game result display means, the first display means, the second display means (including the specific symbols), mentioned respectively, and the like.

Further, as the end timing of displaying in the window frame display areas, the above mentioned timing may be utilized.

And in the embodiment as mentioned, though it is utilized the moving and displaying of the rat fireworks and the enlarging and displaying of the window frame display areas as change in the display mode, the present invention is not limited to these. It may be utilizable as change in the display mode reduction of the window frame display area, change of width thereof, change in color thereof, change in shape thereof and change in moving velocity of the rat fireworks in the embodiment moved and displayed while effect thereby, change in color thereof, change in shape thereof or moving and displaying thereof while changing in shape.

Further, variable display of the window frame display area may be enlargement, reduction, color change coloring change, movement, disappearance, blink thereof and predetermined figures, characters, letters and marks may be moved and displayed along the window frame display area. Further, the window frame display area may be changed so as to be constructed from a plurality of predetermined figures, characters, letters and marks. Thereby, variegated effect can be done.

And the window frame display area may be displayed or moved and displayed corresponding to a predetermined operation by the player and the like person (including clerk and sales person). Further, the window frame display area may be easily moved and displayed corresponding to a specific operation by the player. For example, expectation value (information concerning with the game) may be changed according to the specific operation by the player and the like person, and velocity of moving and displaying of the window frame display area, number, color, coloring, pattern, shape (outer shape or inner shape) thereof may be changed corresponding so-called stock number and the like.

And although the window frame display area corresponds to each reel, the present invention is not limited to this. The window frame display area may be displayed so as to enclose one or plural reels.

And in the embodiment, though the symbol display portions are formed every reel which displays a plurality of symbols while rotating, the present invention is not limited to this. For example, one symbol display area may be formed in the second display means corresponding to one or plural or all of plural reels (plural variable display parts) each of which displays a plurality of symbols while rotating. Entire area of the second display means may construct the symbol display area. The size thereof may be changed.

Further, it is enough that the symbol display area can display the symbols of the first display means, and may be constructed from only member capable of displaying symbols (transparent glass or transparent resin) in which liquid crystal is not provided in the symbol display area.

The first display means or the third display means may be constructed so as to be able to move in directions of up and down, right and left, before and behind, reciprocally move, inducibly vibrate or rotate. In this case, the symbol display part may be constructed so as to move according to the movement of the first display means or the third display means. Based on these operations, it can expect more interesting effect and there may be a case that such operations are applicable for concerning with game contents.

Further, when seeing the front side of the gaming machine, non-display area of symbol, by which the display means arranged at rear side of the second display means cannot be seen and recognized, may be formed in the second display means and the window frame display area may be formed around the area including the symbol display area and the non-display area of symbol. And the window frame display area may be formed inner side than outline of the symbol display area. Here, it is enough that the window frame display area indicates a case that the display means arranged at the rear side of the second display means can be seen when the player directs their eyes to inside of the window frame display area.

Further, the window frame display area may be formed around the symbol display area formed in the second display means, in order to see and recognize the third display means.

And at least a part or entire of the window frame display area may be formed in the symbol display area and light transmittability of a part or entire of the window frame display area formed within the symbol display area may be constructed so as to be variably displayed. Here, at least a part or entire of the window frame display area formed within the symbol display area may be the specific window frame display area.

The above mentioned window frame display area may be constructed so as to conduct variable display such as enlargement, reduction, change in shape and the like. And the gaming machine may be constructed so that a plurality of variable display modes can be controlled to display and one or plural variable display modes are selected among the above mentioned plural variable display modes according to the winning combination (for example, the above mentioned internal winning combination) selected by the winning combination select means (for example, the above mentioned internal winning combination determination means), the winning combination which is internally won but not materialized or random number lottery and the like, and the specific window frame display area is variably displayed based on the selected variable display mode. In that case, the player can see and recognize various specific window frame display areas themselves or the symbols displayed on the first display means through the specific window frame display area. Thus, variegated effect display can be conducted and thereby interest for games conducted in the gaming machine can be improved.

Further, while variably displaying in the specific window frame display area, light transmittability (easiness to see the first display means) thereof may be varied. And the specific window frame display area may have the same light transmittability thereover and the light transmittability in plural stages. As the concrete example, the specific window frame display area may be constructed so as to have high light transmittability (easier to see the first display means) at circumferential part of the center thereof and low light transmittability (harder to see the first display means) at a part according that such part is apart from the circumferential part of the center thereof. Also in the thus constructed case, variegated effect display can be conducted. Further, the light transmittability of the specific window frame display area may be constructed so as to vary in time series (by stages or continuously according to elapsing of time). In that case, velocity or direction in varying of the light transmittability may be changed. Thereby, more profound effect can be realized.

And the gaming machine may be constructed so that the light transmittability of the specific window frame display area is changed according to the winning combination selected by the winning combination select means, the winning combination which is internally won but not materialized or random number lottery and the like. Substantially at the same time, movement and size of the specific window frame display area may be changed. Thereby, the player see change in display of the specific window frame display area while expecting occurrence of the beneficial state, thus not only effect but also interest for games can be improved.

Further, the gaming machine may be constructed so that the window frame display area has a connection with change in size, enlargement, reduction, movement, number and change in outline shape of the symbol display area, and is changed so as to be displayed at a periphery of the symbol display area which is changed according to the above. Thereby, when the player's eyes direct to the window frame display area, it can give the player the thought that the player may be able to see and recognize the first display means through the symbol display area. Therefore, variegated effect can be conducted. Further, the above construction can be also utilized to lead the player's eyes. And such case can contribute to improvement of interest for games.

And there may be a case that the window frame display area is not displayed at the periphery of the symbol display area. As an example of that case, it may be conceivable a case utilized in so-called assist game. In this case, the gaming machine may be constructed so as to include a plurality of stop buttons and a plurality of the window frame display areas corresponding to the plural stop buttons, wherein the internal winning combination is determined based on an output from the game start instruction means, wherein the control means of the gaming machine determines beforehand operation order of the stop buttons (for example, the above mentioned stop buttons) before operations (stop operations) is conducted by the player, and wherein the control means controls the first display means so as to materialize the internal winning combination when actual operation order by the player coincides with the determined operation order. Thereby, display mode of the plural window frame display areas may be changed according to the order corresponding to the operation order of the plural stop buttons, the operation order being determined beforehand by the control means of the gaming machine. In this case, if the player operates the stop buttons corresponding to the window frame display area that the display mode is changed, the internal winning combination is certainly materialized or materialized with high probability. Thereby, it is easy for the player to understand the operation order of the stop buttons, and interest for games is also improved. It is enough that the first display means or the third display means can be seen and recognized through the symbol display area.

Further, the gaming machine may be constructed so that the symbol display area can conduct variable display such as enlargement, reduction or change in shape thereof and the like. Further, the gaming machine may be constructed so that a plurality of variable display modes can be controlled to display and one or plural variable display modes are selected among the above mentioned plural variable display modes according to the winning combination selected by the winning combination select means, the winning combination which is internally won but not materialized or random number lottery and the like, and the symbol display area is variably displayed based on the selected variable display mode. In that case, the player can see and recognize various symbol display areas themselves or the symbols displayed on the first display means through the symbol display areas. Thus, variegated effect display can be conducted and thereby interest for games conducted in the gaming machine can be improved.

Further, while variably displaying the symbol display area, light transmittability (easiness to see the first display means) thereof may be varied. And the symbol display area may have the same light transmittability thereover and the light transmittability in plural stages. As the concrete example, the symbol display area may be constructed so as to have high light transmittability (easier to see the first display means) at circumferential part of the center thereof and low light transmittability (harder to see the first display means) at a part according that such part is apart from the circumferential part of the center thereof. Also in the thus constructed case, variegated effect display can be conducted. Further, the light transmittability of the symbol display area may be constructed so as to vary in time series (by stages or continuously according to elapsing of time). In that case, velocity or direction in varying of the light transmittability may be changed. Thereby, more profound effect can be realized.

And the gaming machine may be constructed so that the light transmittability of the symbol display area is changed according to the winning combination selected by the winning combination select means, the winning combination which is internally won but not materialized or random number lottery and the like. Substantially at the same time, movement and size of the symbol display area may be changed. Thereby, the player see change in display of the symbol display area while expecting occurrence of the beneficial state, thus not only effect but also interest for games can be improved.

And in the embodiment, though the reels 3L, 3C, 3R are adopted as the first display means and the liquid crystal display device 31 is adopted as the second display means, the present invention is not limited to this. For example, CRT, LCD, plasma display, 7-segment LED, LED dot-matrix, lamp, LED, fluorescent lamp, organic EL display, disc, electronic paper, flexible LED, flexible liquid crystal, liquid crystal projector, FED and the like can be adopted as the first display means, the second display means or the third display means. Further, the third display means different from the first display means and the second display means can be arranged at a more front side than the second display means when seeing the front side of the gaming machine, between the first display means and the second display means, or at a more rear side than the first display means when seeing the front side of the gaming machine. The display result displayed on the first display means, the second display means or the third display means is constructed from still images or moving images. The combination, in which two or more or all of the first display means, the second display means and the third display means are combined, can be integrally constructed. In this case, there may be a case that the unit integrally constructed can be wholly exchanged, and this case is preferable since time and labor for decomposing work or assembling work thereof can be omitted and maintenance work can be improved. Further, if parts and construction can be commonly used in the unit, this case is preferable since it can contribute to cost reduction. Of course, if the illumination means commonly utilizable for the common illumination means is included in the unit, the same effect similar to the above can be expected.

Further, the beneficial state includes: a state that a predetermined combination (for example, replay, BB, RB, small combination, single bonus and the like) is materialized; free game; a state that information necessary for the player to favorably advance the game is notified; a state that probability to get internal winning of a predetermined combination is high; a state that winning of a predetermined combination is materialized with high probability; winning of a predetermined combination or a predetermined combination carried over is permitted to materialize with high probability; so-called “challenge time” that the reels are basically stopped based on the operation timing of the stop buttons by the player; small combination; medium combination; big combination; combination (state that so-called “symbol start opening” (symbol variable movement is started when a ball enters in the symbol start opening) is opened or enlarged; so-called “probability changing state”, so-called “time shortening state”); or combination of the above states. Here, the small combination, the medium combination and the big combination concern with a state that so-called “big winning opening” is opened in the so-called Japanese Pachinko gaming machine.

And when the internal winning combination determination means determines a predetermined combination (for example, bonus) as the internal winning combination, one or plural or all of the illumination means included in the common illuminations means can be turned off. For example, the LED lamps 29 arranged for each of the reels 3L, 3C, 3R can be turned off every the operation button corresponding thereto is operated or every the operation button other than the above operation button is operated. Based on the above constructions, interest for games increases. And the forward illumination means (the fluorescent lamps 38a, 38b) can be provided for each of the symbol display parts (the reels 3L, 3C, 3R).

Further, one or plural or all of the illumination means included in the common illumination means can be constructed so as to variably display. For example, still images or moving images can be displayed on the first display means (reel sheet) by changing the turning on mode of the LED lamps 29 or light colors emitted therefrom or by continuously changing those. And self-emitting type plasma display, organic EL display and the like may be adopted as the illumination means (one example of the third illumination means), thereby images can be displayed on the first display means. By this constructions, interest for games increases.

In a case that the special game result (for example, the symbol combination indicating that bonus winning is materialized) is displayed on the first display means or the second display means, it can be provided the special gaming state producing means that the beneficial state for the player is displayed thereon. And both the special gaming state producing means and the second display means can be formed on single control circuit board. And the gaming state can be displayed by superimposing the images displayed on the first display means and the images displayed on the second display means. Further, based on the trigger that a predetermined state is realized, the effect display on the second display means can be done so as to avoid the specific symbols stopped and displayed on the symbol display part or so as to superimpose the specific symbols. If the gaming state is displayed by the superimposed images, the beneficial state for the player may be produced with high probability in comparison with the case in which the superimposed images is not displayed. Thereby, it can include the effect that the player's expectation increases, in excess of the previous case. Thus, such effect can contribute to increase of interest.

In the embodiment, though the start lever 10 is adopted as the game start instruction means, the present invention is not limited to this. For example, the BET switch 5, the medal insertion slot 6, the medal sensor 6S or the start switch 10S can be adopted.

The display includes: display by the sense of sight, display by the sense of hearing, notification by the sense of smelling, turning on of the lamps or combination of those. The display mode includes: colors, patterns, shapes (outline shapes, interior shapes) and the like. And the game result can be displayed after operation of the game start instruction means or the game result leading means.

In the embodiment, though the above mentioned LED drive circuit is utilized as the display control means for a plurality of the ornamental lamps, the LED lamps and the fluorescent lamps, each of which is arranged in the cabinet, the present invention is not limited to this. Turning on control of the LED lamps may be conducted by another display control means. In this case, for example, in turning on control of the LED lamps, electric power may be provided so that the LED lamps are always turned on during a period from power-on of the gaming machine till power-off thereof. Here, turning on includes blinking mode that the LED lamps are intermittently blinked with a very short time interval. Thus, since the LED lamps are always turned on, light emitted from the LED lamps always illuminates each symbol display area even if abnormality occurs in the mentioned LED drive circuit. Thereby, the player can always see the symbols arranged on each of the reels through the each symbol display areas, thus the above turning on control is preferable.

Further, turning on control of the above mentioned fluorescent lamps may be done by another display control means. In this case, for example, in the turning on control of the fluorescent lamps, electric power may be provided so that the fluorescent lamps are always turned on during a period from power-on of the gaming machine till power-off thereof. Thereby, similar to the above, light emitted from the fluorescent lamps always illuminates each symbol display area even if abnormality occurs in the mentioned LED drive circuit. Thereby, the player can always see and recognize the symbols arranged on each of the reels through the each symbol display areas

Further, in the embodiment, though the above mentioned sub-CPU conducts display control of a plurality of the ornamental lamps arranged in the cabinet, sound output control and image display control of the liquid crystal display device, the present invention is not limited to this. Another sub-CPU separate from the above sub-CPU may conduct the above various controls. For example, in a case that another sub-CPU separate from the above sub-CPU conducts the control of a plurality of the ornamental lamps arranged in the cabinet and, for example, in a case that abnormality occurs in the display control, it is enough to exchange only the sub-CPU with abnormality occurrence or only the circuit construction including the sub-CPU with abnormality occurrence to the normal sub-CPU or circuit construction having the normal sub-CPU. Therefore, time and labor for removing the cause of the abnormality occurrence can be omitted and such construction is very preferable. And in a case that another sub-CPU other than the above sub-CPU conducts sound output control or image display control, or for example, in a case that abnormality occurs in the sound output control or the image display control, it is enough to exchange only the sub-CPU with abnormality occurrence or only circuit construction including the sub-CPU with abnormality occurrence.

Further, the liquid crystal display device described in the embodiment may have image enlarging means for enlarging the input images by a predetermined magnification. For example, the image enlarging means may convert the image data for 640×480 dots into the image data for 1024×768 dots and output the converted image data to the display part (above mentioned terminal part). Thereby, it can use the image data for small display area, the data quantity thereof being less in comparison with that for the factual display area. As a result, memory quantity of the ROM and image data forming time can be reduced.

And in the embodiment, though the symbol display area is divided corresponding to each of three reels 3L, 3C, 3R, the present invention is not limited to this and the symbol display area may be formed so as not to be divided. For example, it may be conceivable that two or three of the reels 3L, 3C, 3R can be seen and recognized through one symbol display area. And if the first display means and the third display means are arranged at the rear face or side of the second display means, it may be constructed that the player sees and recognizes through one symbol display area a part or whole of the first display means and a part or whole of the third display means. When the reflection means is produced, there may be a case that the reflection means can be easily produced in comparison with a case that a plurality of transparent portions are formed dividedly.

Further, the present invention can apply to Japanese Pachinko gaming machine, arrange ball gaming machine, mah-jong ball gaming machine, video-slot machine, video poker machine and the other machines, in addition to the slot machine in the embodiment. And even in the game program imitatively executing operation of the above mentioned slot machine in a family gaming machine, the present invention can apply and execute the game. In this case, CD-ROM, FD (flexible disc) and the similar memory medium can be utilized for the memory medium for storing the game program.

Here, recently in the Japanese Pachinko gaming machine in the main current, the gaming machine, in which an electric display device such as the liquid crystal display device is arranged at the center of gaming plate, is popularized. In this electric display device, a plurality of symbols (abbreviated as “special symbols” hereinafter) represented by images are variably displayed, thereby three lines of reels in the slot machine are imitatively displayed. When variable display of the special symbols stops and a predetermined stop mode (in which the same special symbols stop such as 7-7-7 and this stop mode is generally called “big combination”), the game shifts to the special gaming state beneficial for the player. In general Japanese Pachinko gaming machine, the variable display of the special symbols is started on condition that balls shot within the gaming plate by operation of the shooting handle enter into a predetermined winning hole (so-called “variable display start hole”). After a predetermined time is elapsed the variable display of the special symbols stops.

In this kind of Japanese Pachinko gaming machine, it may be arranged the liquid crystal display device (the second display means) and the first display means (for example, drum-type reels) at a more rear side than the display area (display plane) of the liquid crystal display device when seeing the front side of the gaming machine. And the special symbols may be variably displayed on one or both of the first display means (for example, the liquid crystal display device) and the second display means (for example, drum-type reels).

The above mentioned game result display means may be constructed so as to include the first display means and the second display means provided at a more front side than the display area of the first display means when seeing the front surface of the gaming machine. And the game result display means may be constructed so as to include the first display means and the second display means provided at a more front side than the display area of the first display means when seeing the front side of the gaming machine.

The above mentioned rearward illumination means illuminates the second display means from the backside thereof. And the above mentioned front illumination means illuminates the second display means from the backside of thereof. And the front illumination means may illuminate the second display means from the side plane thereof.

The above mentioned first display means and/or the second display means may be formed in a curved shape. As for extent of the curvature, the first display means and the second display means may have substantially the same curvature. Thereby, there may be a case that design of the gaming machine is improved and the gaming machine is made attractive. Even if the first display means is curved with a small radius of curvature or with a large radius of curvature, the above same effect can be obtained.

The above mentioned reflection means corresponds to means which has at least function to refract a part or whole of light led by the light leading means toward the liquid crystal panel and illuminate the liquid crystal panel.

The above mentioned game start instruction means may be a variable symbol display start hole which produces an output signal when the winning combination or passage of the ball is detected. The game start instruction means in the ball flipping machine corresponds to the variable display start hole for the special symbols (or the start gate), the variable display start hole for the common symbols, the various judging symbol display start holes (or the start gates).

In a case that the above mentioned internal winning combination determination means determines the predetermined combination as the internal winning combination, one or plural illumination means included in the common illumination means is/are turned off. Or the illumination means may always be turned off.

There may be a case that one or plural illumination means included in the common illumination means is/are turned off at the substantially same timing that the above mentioned internal winning combination determination means determines the predetermined combination as the internal winning combination. Or the illumination means may always be turned off.

As for variable display by the illumination means included in the common illumination means, it is conceivable various display modes. For example, it may be constructed so as to be able to execute the special symbol variable display. Here, the special symbol variable display can be executed in the mode such as: brightness in a part or whole of the display part in the illumination means differs from that in the non-specific symbol variable display; still images, moving images, specific letters, numbers, figures, characters, which are not displayed in the non-specific symbol variable display, are displayed; variable display speed differs from that in the non-specific symbol variable display. Further, voluntary display modes may be utilized. And in a case that the specific symbol variable display is conducted, it may be constructed that the beneficial state for the player occurs with high probability in comparison with the case that the specific symbol variable display is not done. Thereby, it can be included the effect that the player's expectation increases, in excess of the previous case. Thus, such effect can contribute to increase of interest.

As for the means adopted as the third display means, it may be adopted display devices which is applicable as the first display means and the second display means, as mentioned above. It may be a case that one or plural effect display reels is/are utilized as the third display means, and both the first display means and the third means are arranged at the rear surface or side of the second display means. In this case, the symbol display area through which the player sees the display area of the third display means may be provided in the second display means. Thereby, the player can easily recognize the display contents on the display area of the third display means, thus this construction is very preferable.

Further, it may be controlled so that the images formed by superimposing the images of the second display means and the images of the third display means are seen by the player, and when such control occurs, the beneficial state occurs with higher probability than the case that such control does not occur. Thereby, it can be included the effect that the player's expectation increases, in excess of the previous case. Thus, such effect can contribute to increase of interest.

Further, any one of the first display means, the second display means and the third display means may be constructed form a movable structure with shapes such as figures, dolls, animals, insects, famous structures, fishes, vehicles. For example, the above structures may be moved with rotation, swing, reciprocal movement or vibration in cases that: the special combination is internally won, the special combination is materialized, the number of the combination which is as same as the special combination internally won but not materialized exceeds a predetermined number, the special images are displayed on the display means different from the above structures. And there may be a case that the above structure is constructed from plural members and a part of the members is/are moved. In this case, there may be a case that it can be further expected more various effects by displaying on other than the image display device.

Further, the front illumination means may be arranged at the front side of the first display means and the second display means. In this case, if the inside of the game arcade is dark, the front illumination means can illuminate both the first display means and the second display means with enough light. Therefore, there may be a case that the player can clearly recognize the images displayed on the display means, thus it can be expected that the player can enjoy more various effect in the gaming machine.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

This application is related to co-pending U.S. patent applications entitles “GAMING MACHINE” referred to as Attorney Cocket No, SHO-0019, “GAMING MACHINE” referred to as Attorney Docket No. SHO-0020, “GAMING MACHINE” referred to as Attorney Docket No. SHO-0021, “GAMING MACHINE” referred to as Attorney Docket No. SHO-0022, “GAMING MACHINE” referred to as Attorney Docket No. SHO-0023, “GAMING MACHINE” referred to as Attorney Docket No. SHO-0024, “GAMING MACHINE” referred to as Attorney Docket No. SHO-0025, “GAMING MACHINE” referred to as Attorney Docket No. SHO-0026, “GAMING MACHINE” referred to as Attorney Docket No. SHO-0027, “GAMING MACHINE” referred to as Attorney Docket No. SHO-0028, “GAMING MACHINE” referred to as Attorney Docket No. SHO-0029, “GAMING MACHINE” referred to as Attorney Docket No. SHO-0030, “GAMING MACHINE” referred to as Attorney Docket No. SHO-0031, “GAMING MACHINE” referred to as Attorney Docket No. SHO-0032, “GAMING MACHINE” referred to as Attorney Docket No. SHO-0033, “GAMING MACHINE” referred to as Attorney Docket No. SHO-0034, “GAMING MACHINE” referred to as Attorney Docket No. SHO-0035, “GAMING MACHINE” referred to as Attorney Docket No. SHO-0036, “GAMING MACHINE” referred to as Attorney Docket No. SHO-0037, “GAMING MACHINE” referred to as Attorney Docket No. SHO-0038, “GAMING MACHINE” referred to as Attorney Docket No. SHO-0039, “GAMING MACHINE” referred to as Attorney Docket No. SHO-0040, “GAMING MACHINE” referred to as Attorney Docket No. SHO-0041, “GAMING MACHINE” referred to as Attorney Docket No. SHO-0042, “GAMING MACHINE” referred to as Attorney Docket No. SHO-0043, “GAMING MACHINE” referred to as Attorney Docket No. SHO-0044, “GAMING MACHINE” referred to as Attorney Docket No. SHO-0045, “GAMING MACHINE” referred to as Attorney Docket No. SHO-0046, “GAMING MACHINE” referred to as Attorney Docket No. SHO-0047, “GAMING MACHINE” referred to as Attorney Docket No. SHO-0048, “GAMING MACHINE” referred to as Attorney Docket No. SHO-0049, “GAMING MACHINE” referred to as Attorney Docket No. SHO-0050, “GAMING MACHINE” referred to as Attorney Docket No. SHO-0051, “GAMING MACHINE” referred to as Attorney Docket No. SHO-0052, “MOTOR STOP CONTROL DEVICE” referred to as Attorney Docket No. 0053, “GAMING MACHINE” referred to as Attorney Docket No. SHO-0054, “GAMING MACHINE” referred to as Attorney Docket No. SHO-0055, “GAMING MACHINE” referred to as Attorney Docket No. SHO-0056, “GAMING MACHINE” referred to as Attorney Docket No. SHO-0057, respectively, all the applications being filed on Oct. 31, 2003, herewith. The co-pending applications including specifications, drawings and claims are expressly incorporated herein by reference in their entirety.

What is claimed is:

1. A gaming machine comprising:
game result display means for displaying a game result thereon; and
beneficial state generating means for generating a beneficial state for a player when a predetermined game result is displayed on the game result display means;
wherein the game result display means includes first display means and second display means arranged at a more front side than a display area of the first display means when seen from a front side of the gaming machine,
wherein the first display means includes a plurality of symbol display parts capable of variably displaying one or more of the symbols and conducting stop display thereof, and
wherein the second display means has symbol display areas through which the symbols displayed on the first display means are transmittably displayed and window frame display areas are formed around the symbol display areas in the second display means.

2. The gaming machine according to claim 1, wherein display mode of the window frame display area is changed.

3. The gaming machine according to claim 2, wherein a light transmittance rate of the symbol display area in the second display means is changed when the display mode of the window frame display area is changed.

4. The gaming machine according to claim 2, wherein the display mode of the window frame display area is changed substantially at the same time that the stop display of the symbol is conducted.

5. The gaming machine according to claim 2, further comprising:
internal winning combination determination means for determining an internal winning combination;
wherein the display mode of the window frame display area is changed when the internal winning combination determination means determines a predetermined combination as the internal winning combination.
